(19) United States
(12) Patent Application Publication
(10) Pub. No.: US 2012/0100757 A1
(43) Pub. Date: Apr. 26, 2012

(54) ELECTRICAL CONNECTOR WITH IMPROVED CONTACTS

(75) Inventors: CHIEN-HSUN HUANG, New Taipei (TW); YUN-SONG SUN, Kunshan (CN)

(73) Assignee: HON HAI PRECISION INDUSTRY CO., LTD., New Taipei (TW)

(21) Appl. No.: 13/276,338

(22) Filed: Oct. 19, 2011

(30) Foreign Application Priority Data
Oct. 23, 2010 (CN) 201010516586.9

(51) Int. Cl. H01R 24/20; H01R 13/02

(52) U.S. Cl. 439/626; 439/889

(57) ABSTRACT

An electrical connector, comprising an insulative housing, at least two conductive terminals received in the insulative housing and defining an upper terminal and a lower terminal, each conductive terminal comprising a retaining portion retained in the insulative housing, a mating portion extending forwardly from the retaining portion and a soldering portion extending rearwardly from the retaining portion. The structures of the upper terminal and the lower terminal are the same as each other. The mating portions of the upper terminal and the lower terminal are arranged in two rows. The soldering portions of the upper terminal and the lower terminal are arranged in one row.

### FIELD OF THE INVENTION

The present invention relates to an electrical connector, and more particularly to an electrical connector with improved contacts.

### DESCRIPTION OF PRIOR ART

Wire harness connector is widely used in many electrical device for its good transmitting feature. CN Pat. No. CN201438553U, issued on Apr. 14, 2010, disclosed an electrical connector comprising an insulative housing, a number of conductive terminals received in the insulative housing, a number of wires electrically each connected respectively to a tail of each conductive terminal and a spacer assembled behind the insulative housing. All conductive terminals are arranged in two rows. Each of conductive terminal includes a flat portion, a pair of retaining arms extending perpendicular from two sides of the flat portion, a touching portion extending forwardly form a front end of the retaining arm and a connecting portion located on a rear end of the flat portion. The connecting portion is flat. The retaining portions combines with the flat portion to form a U-shape. A pair of mating portions are extended bending forwardly from the retaining portions.

By automation operation, conductive terminals are assembled in the insulative housing and soldered to the wires. Due to the connecting portion being in two rows, implementation automating soldering is inconveniently. That all wires are completely connected to the connecting portion needs twice soldering operation. Firstly, partly wires are soldered on the first row of the connecting portion. Secondly, the other wires are soldered on the second row of the connecting portion.

As discussed above, an improved electrical connector overcoming the shortages of existing technology is needed.

### SUMMARY OF THE INVENTION

Accordingly, an object of the present invention is to provide an electrical connector with a number of wires soldered conveniently to conductive terminals corresponded to the wires, respectively.

In order to achieve the above-mentioned objects, an electrical connector, comprising an insulative housing, at least two conductive terminals received in the insulative housing and defining an upper terminal and a lower terminal, each conductive terminal comprising a retaining portion retained in the insulative housing, a mating portion extending forwardly from the retaining portion and a soldering portion extending rearwardly from the retaining portion. Wherein the structure of the upper terminal and the lower terminal are the same as each other. The mating portion of the upper terminal and the lower terminal are arranged in two rows. The soldering portions of the upper terminal and the lower terminal are arranged in one row.

Other objects, features and advantages of the invention will be apparent from the following detailed description taken in connection with the accompanying drawings.

### BRIEF DESCRIPTION OF THE DRAWINGS

FIG. 1 is a perspective view of an electrical connector in accordance with the present invention;

FIG. 2 is an exploded, perspective view of the electrical connector shown in FIG. 1;

FIG. 3 is a view similar to FIG. 2, but from another aspect; and

FIG. 4 is an enlargement, perspective view of a pair of conductive terminals of the electrical connector shown in FIG. 2.

### DETAILED DESCRIPTION OF PREFERRED EMBODIMENTS

Reference will now be made to the drawing figures to describe the present invention in detail.

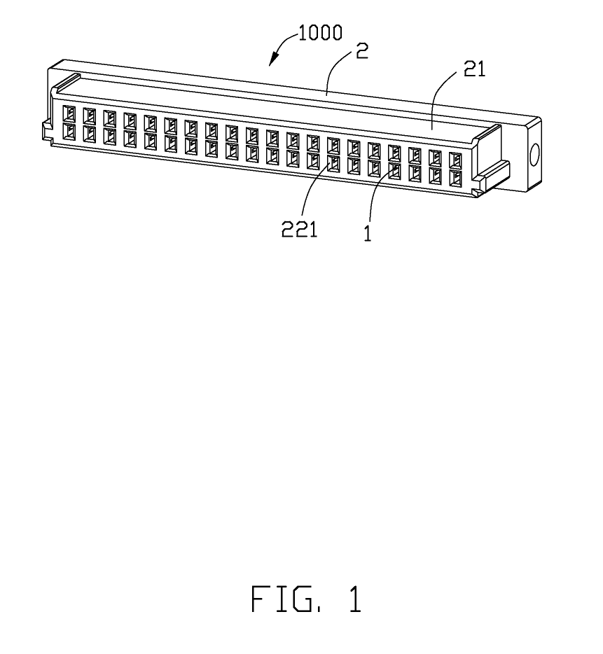

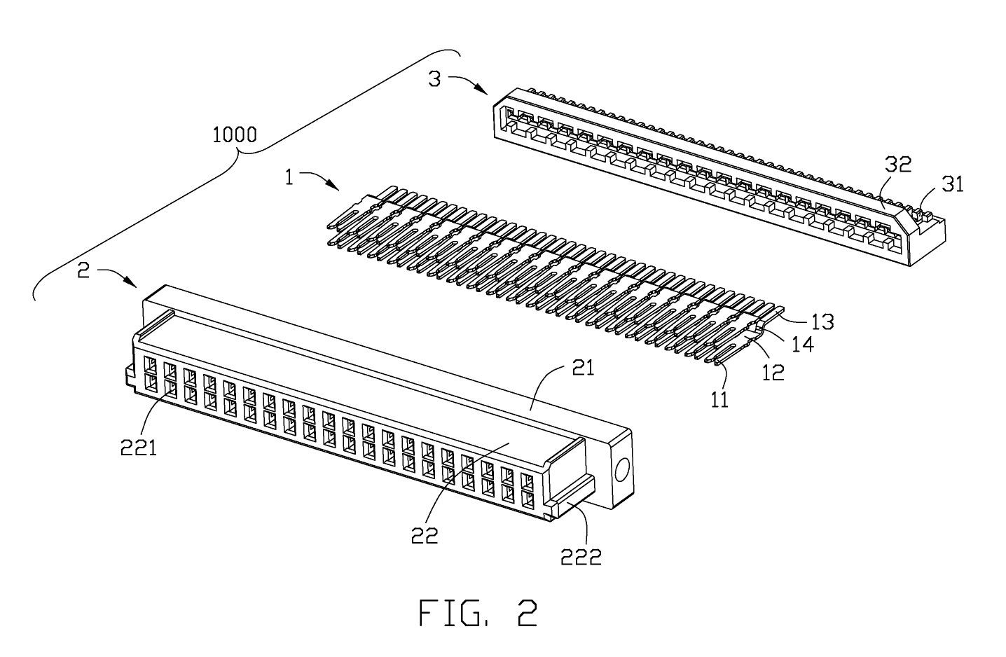

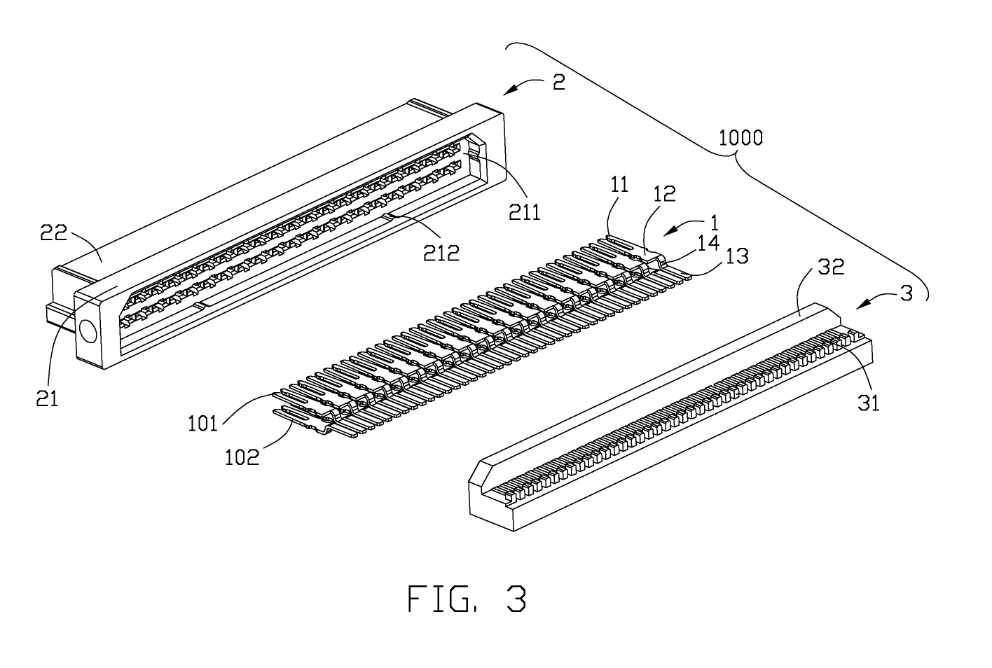

Referring to FIGS. 1 to 3, an electrical connector 100 in accordance with the present invention comprises an insulative housing 2, a plurality of conductive terminals 1 received in the insulative housing 2 and a spacer 3 assembled in the insulative housing 2. The conductive terminals 1 include upper terminals 101 and lower terminals 102. The structure of upper terminal 101 is as same to the structure of the lower terminal 102.

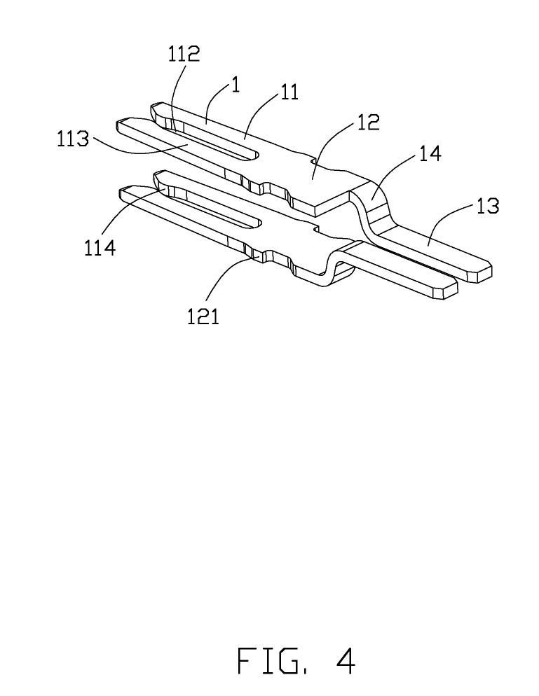

Referring to FIG. 4, each conductive terminal 1 is a sheet structure and Z-shaped. The conductive terminal 1 comprises a retaining portion 12, a mating portion 11 extending forwardly from the retaining portion 12, a connecting portion 14 extending bending from a rear end of the retaining portion 12 and a soldering portion 13 extending rearwardly and bending from a rear end of the connecting portion 14. The retaining portion 12 and the mating portion 11 are located on the same plane. The soldering portion 13 is parallel to the mating portion 11 and the retaining portion 12. The retaining portion 12 and the mating portion 11 are centrosymmetric structure, respectively.

The mating portion 11 has a through groove 112 locating on the centre thereof, a pair of inserting portions 113 located on two sides of the through groove 112 and a pair of convexes 114 respectively extending inwardly from an inner surface of the inserting portions 113. Two inserting portion 113 are symmetry. The inner surface of the inserting portion 113 is blanking and mates to a mating terminal (not shown) of a complementary connector (not shown). The function of the convex 14 is to make the conductive terminal 1 more stably mate to the mating terminal (not shown). The retaining portion 12 has a pair of hangnails 121 located respectively on the two sides thereof. The hangnail 121 can make the conductive terminal stably receive in the insulative housing 1. The conductive terminal 1 is not retreated by external force.

A lateral side of the connecting portion 14 and a lateral side of the soldering portion 13 are alignment to a lateral side of the retaining portion 12. The width of the soldering portion 13 is shorter than the half width of the retaining portion 12. The connecting portion 14 and the soldering portion 13 deviate the symmetry axis of the retaining portion 12 and the mating portion 11. The width of the connecting portion 14 is same as the width of the soldering portion 13. In other embodiments, The width of the connecting portion 14 can be different from the width of the soldering portion 13. The lateral sides of the connecting portion 14 and the soldering portion 13 can be beyond or below the lateral side of the retaining portion 12. The alignment technology method is a best embodiment.

The insulative housing 2 is made of the plastic material and defines a basic portion 21 and an inserting portion 22 extending forwardly from the basic portion 21. The inserting portion 22 has a number of receiving holes 221 which are arranged in two rows. The inserting portion has a pair of guiding portion 222 located at two sides thereof for guiding the electrical connector 100 connecting to the complementary connector. The basic portion 21 comprises a receiving groove 211 recessing forwardly from a rear surface thereof and a plurality of ribs 212 located on a lateral wall of the receiving groove 211. The receiving groove 211 is communicated with the receiving holes 221.

The spacer 3 is molded by plastic material and defines a plurality of slits 31 located behind a rear surface thereof and a protruding portion 32 located on the front thereof. The slits 31 run through the protruding portion 32.

In assembly, the conductive terminals 1 are respectively inserted into the receiving holes 221 from the rear end of the insulative housing 2. The mating portions 11 of upper terminals 101 are aligned to the mating portions 11 of the lower terminals 102 up and down, which are arranged in two rows. The retaining portions 12 of upper terminals 101 are alignment to the retaining portions 12 of the lower terminals 102 in a direction of the upper and down, which are arranged in two rows. The soldering portions 13 of the upper terminals 101 and the lower terminals are arranged cross-cutting in a row. The protruding portion 32 is received in the receiving groove 211. A lateral side of the protruding portion 32 and a lower surface of the space 3 are attached to the ribs 212 for the space 3 retaining in the insulative housing 2. The soldering portions 13 of the conductive terminals 1 are received respectively in the slits 31 and the upper surface of the soldering portions 13 are exposed on the upper surface of the spacer 3.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector, comprising:
an insulative housing; and
at least two conductive terminals received in the insulative housing and defining an upper terminal and a lower terminal, each conductive terminal comprising a retaining portion retained in the insulative housing, a mating portion extending forwardly from the retaining portion and a soldering portion extending rearwardly from the retaining portion; wherein
the structures of the upper terminal and the lower terminal are the same as each other, the mating portions of the upper terminal and the lower terminal are arranged in two rows, and the soldering portions of the upper terminal and the lower terminal are arranged in one row.

2. The electrical connector as recited in claim 1, wherein the soldering portions of the upper terminals and the lower terminals are arranged cross-cutting in a row when the number of the conductive terminals are more than two.

3. The electrical connector as recited in claim 1, wherein the retaining portion of the upper terminal is aligned to the retaining portion of the lower terminal up and down.

4. The electrical connector as recited in claim 3, wherein the electrical connector also comprises a space assembled in the insulative housing.

5. The electrical connector as recited in claim 1, wherein the spacer defines a protruding portion located on a front end thereof.

6. The electrical connector as recited in claim 5, wherein the insulative housing defines a receiving groove receiving the protruding portion.

7. The electrical connector as recited in claim 6, wherein a surface of the soldering portion is exposed out of the surface of the spacer.

8. A conductive terminal with a sheet structure, comprising:
a retaining portion;
a mating portion extending forwardly from the retaining portion;
a connecting portion extending bending from a rear end of the retaining portion; and
a soldering portion extending bending and forwardly from a rear end of the connecting portion,
wherein the soldering portion deviates the symmetry axis of the retaining portion.

9. The conductive terminal as recited in claim 8, wherein a lateral side of the soldering portion is alignment to a lateral side of the retaining portion.

10. The conductive terminal as recited in claim 9, wherein the width of the soldering portion is shorter than the half width of a rear end of the retaining portion.

11. The conductive terminal as recited in claim 10, wherein a pair hangnails are located respectively on the lateral sides of the retaining portion.

12. The conductive terminal as recited in claim 8, wherein the retaining portion and the mating portion are a same plane.

13. The conductive terminal as recited in claim 12, wherein the soldering portion, the mating portion and the soldering portion are different planes.

14. The conductive terminal as recited in claim 13, wherein the mating portion has a through groove located on the center thereof, a pair of inserting portion located two sides of through groove and a convex extending inwardly from a front end of each inserting portion.

15. The conductive terminal as recited in claim 14, wherein two inner surfaces of the inserting portion are blanking for mating to a mating terminals.

16. An electrical connector for mating with a complementary connector, comprising:
an insulative housing defining a longitudinal direction and a transverse direction perpendicular to each other;
a plurality of passageways arranged in first and second rows along the longitudinal direction, each of said passageways extending through the housing in a front-to-back direction perpendicular to said transverse direction, the passageways in the first row being aligned with the corresponding passageways in the second row, respectively, in the transverse direction in a paired manner;
two rows of terminals disposed in the corresponding passageways, respectively, and thus being with pairs, each of the terminals defining a front mating section disposed in the corresponding passageway for mating with a corresponding contact of the complementary connector and a rear connecting section exposed outside of the housing for connecting to a corresponding wire; wherein
in each pair of terminals, the connecting section of the terminal in the first row is offset from that of the terminal in the second row along the transverse direction while is aligned with each other in the longitudinal direction at a middle position between the first row of the passageways and the second row of the passageways in the transverse direction.

17. The electrical connector as claimed in claim 16, wherein in each of the terminals, the mating section is dimensioned twice the connecting section in the transverse direction.

18. The electrical connector as claimed in claim 17, further including a spacer with two rows of dents in a front face and one row of grooves in a rear face, wherein each of said dents receives a front portion of the corresponding connecting section, and each of said grooves receives a rear portion of the corresponding connecting section.

19. The electrical connector as claimed in claim 18, wherein in each of the terminals, the front portion of the connecting section offsets the rear portion of the connecting section from the mating section in the transverse direction.

20. The electrical connector as claimed in claim 19, wherein in each of the terminals in the first row of passageways, the corresponding connecting section extends from one transverse side of the corresponding mating section while in each of the terminals in the second row of passageways, the corresponding connecting section extends from the other transverse side of the corresponding mating section so as to allow the terminals in the first row of passageways and those in the second row of passageways share a same configuration for saving mold manufacturing cost but disposed in the corresponding passageways in a reverse manner.
